(19) United States
(12) Patent Application Publication
(10) Pub. No.: US 2008/0150441 A1
(43) Pub. Date: Jun. 26, 2008

(54) POWER SOURCE UNIT FOR DISCHARGE LAMP AND METHOD OF CONTROLLING THE SAME

(75) Inventor: Akira YOSHIDA, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/935,526

(22) Filed: Nov. 6, 2007

(30) Foreign Application Priority Data
Dec. 20, 2006 (JP) 2006342485

(51) Int. Cl. H05B 37/02

(52) U.S. Cl. 315/209 R

(57) ABSTRACT

A D.C. voltage from a D.C. power source portion is switched at a predetermined duty and oscillation frequency by a switching element in accordance with a high-frequency pulse from a pulse generating circuit. After the resulting output current is smoothed by a smoothing circuit, the smoothed current is supplied to a discharge lamp. The pulse generating circuit operates so that the duty is controlled in accordance with an output from a current controlling circuit which operates in accordance with a feedback signal from a current detecting resistor, and an oscillation frequency is temporarily held high in accordance with an output from a pulse frequency-changing circuit which operates in accordance with a frequency command (C_{f}) outputted for a partial period, t, of time within a period, T, of time for display a green display color.

The present application claims priority from Japanese patent application No. 2006-342485, filed on Dec. 26, 2006, the entire contents of which are incorporated herein by reference.

### BACKGROUND

1. Field

One embodiment of the invention relates to a power source unit for a discharge lamp which is used in a projection type image displaying apparatus or the like using a discharge lamp as a light source, and a method of controlling the same.

2. Description of the Related Art

An image displaying apparatus utilizing a color-sequential system including digital light processing (DLP: a registered trademark of Texas Instruments Inc.) using a digital micromirror device (DMD: a registered trademark of Texas Instruments Inc.) is known as one of image displaying apparatuses. The image displaying apparatus utilizing this color-sequential system is constructed such that color filters which have filters of the three primary colors having red (R), green (G) and blue (B) and which are adapted to rotate, a condenser lens, a DMD, a projection lens are disposed in order on an optical path between a light source lamp for emitting a white light and a screen. The image displaying apparatus utilizing the color-sequential system, for example, is disclosed in the Japanese Patent Kokai No. 2000-231066.

A discharge lamp is used as the above-mentioned light source lamp in many cases. The discharge lamp is driven by a power source unit for a lamp including a D.C. power source, a switching element for switching a D.C. voltage generated by the D.C. power source, and a smoothing circuit for smoothing an output current from the switching element, and supplying the resulting smoothed current to the discharge lamp.

Some discharge lamps have an emission spectrum in which a green component shows a stronger intensity than that of each of red and blue components. When the discharge lamp having such optical characteristics is used as the light source, an image having a white balance in which the green component shows the strong intensity is obtained, which makes an impression of a displayed image worse for a viewer. In order to solve this problem, a display apparatus is proposed in which a green component is relatively suppressed to obtain a balance with other color components (a red component and a blue component) having respective wavelength bands, so that an image is displayed with an optimal white balance. This display apparatus, for example, is disclosed in the Japanese Patent No. 3797342.

A power source unit for a discharge lamp in this display apparatus performs switching in a state in which a lamp current is separated into a lamp current (+IL) in a positive polarity state and a lamp current (−IL) in a negative polarity state. Also, this power source unit for a discharge lamp sets a lamp current value at a low level in correspondence to a period of time for display of green at start of polarity switching, gradually increases the lamp current value with the progress of time from the period of time for the green display to a period of time for display for red display through a period of time for blue display, and performs the polarity switching at a time point when the lamp current value reaches a predetermined value. As a result, it is possible to obtain the optimal white balance in the discharge lamp.

However, the conventional power source unit for a display lamp involves such a problem that the complicated control operation is required because the polarity switching must be performed and also the lamp current value must be controlled, which results in the construction being complicated.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic view showing a construction of an image displaying apparatus according to an embodiment of the invention;

FIG. 2 is an exemplary circuit diagram showing a detailed circuit structure of a power source unit for a discharge lamp in the image displaying apparatus according to the embodiment of the invention;

FIG. 3A is an exemplary schematic timing chart showing colors of lights from a color wheel in operations of respective portions in the power source unit for a discharge lamp shown in FIG. 2;

FIG. 3B is an exemplary schematic timing chart showing a timing at which a small lamp current is caused to flow through the discharge lamp only for a period of time for a small lamp current in the operations of the respective portions in the power source unit for a discharge lamp shown in FIG. 2;

FIG. 3C is an exemplary schematic timing chart showing an operation mode of a pulse frequency-changing circuit in the operations of the respective portions in the power source unit for a discharge lamp shown in FIG. 2;

FIG. 3D is an exemplary schematic timing chart showing a state of an operation frequency of a pulse generating circuit in the operations of the respective portions in the power source unit for a discharge lamp shown in FIG. 2;

FIG. 4A is an exemplary waveform chart showing a change in duty of a switching element in characteristics when a duty for an ON period of time of a switching element is changed in order to reduce a quantity of light;

FIG. 4B is an exemplary characteristic diagram showing a triangular waveform of a lamp current caused to flow through the discharge lamp and an average value of the triangular waveform of the lamp current when no oscillation frequency of a pulse generating circuit is changed in the characteristics when the duty for the ON period of time of the switching element is changed in order to reduce the quantity of light; and

FIG. 4C is an exemplary characteristic diagram showing a triangular waveform of a lamp current caused to flow through the discharge lamp and an average value of the triangular waveform of the lamp current in an example of the invention in the characteristics when the duty for the ON period of time of the switching element is changed in order to reduce the quantity of light.

### DETAILED DESCRIPTION OF PREFERRED EMBODIMENTS

Various embodiments according to the invention will be described hereinafter with reference to the accompanying drawings. In general, according to one embodiment of the invention, there is provided a power source unit for a discharge lamp, in which a lamp current caused to flow through the discharge lamp which is driven by a switching element by using a D.C. power source as a power source has a period of time for a large lamp current and a period of time for a small lamp current, the discharge lamp is driven for the period of time for a large lamp current by a high-frequency pulse having a first frequency, and the discharge lamp is driven for the period of time for a small lamp current by a high-frequency pulse having a second frequency higher than the first frequency.

According to the constitution as described above, the quantity of light emitted from the discharge lamp for the period of time for a small lamp current can be reduced without exerting a bad influence on the period of time for a large lamp current by using such a simple constitution that the high-frequency pulse for the period of time for a large lamp current is made different in frequency from that for the period of time for a small lamp current.

In addition, according to a further embodiment of the invention, there is provided a power source unit for a discharge lamp, including: a switching element for driving the discharge lamp by using a D.C. power source as a power source; a pulse generating circuit for switching the switching element by a high-frequency pulse; and a pulse frequency-changing circuit for controlling the pulse generating circuit so that the pulse generating circuit generates the high-frequency pulse with a first frequency for a first period of time within a predetermined period of time which is periodically repeated, and generates the high-frequency pulse with a second frequency higher than the first frequency within the predetermined period of time.

According to the constitution as described above, it is possible to structure the power source unit for a discharge lamp in which a quantity of light emitted from the discharge lamp for the second period of time without exerting a bad influence on the first period of time by using such a simple constitution that the frequency for the second period of time is made higher than that for the first period of time.

In addition, according to a still further embodiment of the invention, there is provided a method of controlling a power source unit for a discharge lamp, including the steps of: driving the discharge lamp for a period of time for a large lamp current of the period of time for a large lamp current and a period of time for a small lamp current by a high-frequency pulse having a first frequency, a lamp current caused to flow through the discharge lamp driven by a switching element by using a D.C. power source as a power source having the period of time for a large lamp current and the period of time for a small lamp current; and driving the discharge lamp for the period of time for a small lamp current by a high-frequency pulse having a second frequency higher than the first frequency.

According to the control method as described above, it is possible to reduce a quantity of light emitted from the discharge lamp for the period of time for a small lamp current without exerting a bad influence on the period of time for a large lamp current by utilizing such a simple method that the frequency for the period of time for a small lamp current is made different from that for the period of time for a large lamp current.

According to the power source unit for a discharge lamp, and the method of controlling the same of the invention, it is possible to perform the control for reducing the quantity of light emitted from the discharge lamp only for the specific period of time in contrast with other period of time within the predetermined period of time which is periodically repeated.

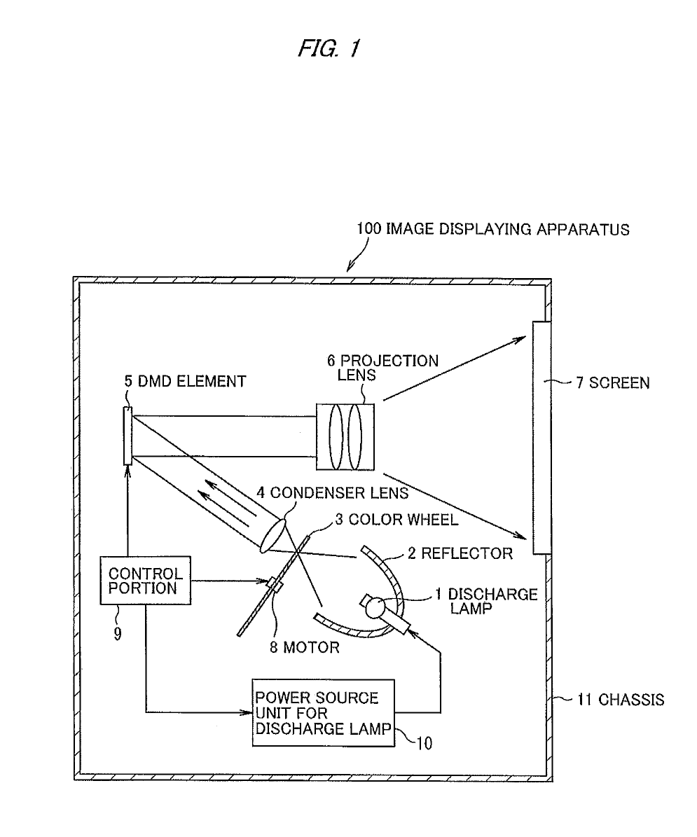

FIG. 1 shows an image displaying apparatus according to an embodiment of the invention. The image displaying apparatus 100 includes a discharge lamp 1 as a light source for emitting a white light, a reflector 2 for reflecting the white light emitted from the discharge lamp 1 in a predetermined direction, a color wheel 3 including filters having the three primary colors R, G and B, a condenser lens 4 for converting the light from the color wheel 3 into a parallel light, a DMD element 5 for selecting the lights obtained through the condenser lens 4, and outputting the resulting optical image in a projection direction, a projection lens 6 for projecting the optical image from the DMD element 5 on a projection surface of a screen 7, the screen 7 having the projection surface on which the optical image through the projection lens 6 is projected, a motor 8 for rotation-driving the color wheel 3, a control portion 9 for controlling the DMD element 5 and the motor 8, a power source unit 10 for a discharge lamp for controlling light emission of the discharge lamp 1 under the control by the controller 9, and a chassis 11 which accommodates therein all the portions described above and in which the screen 7 is installed so as to be visible from the outside.

For example, a short-arc lamp, an ultra-high pressure type mercury lamp, a metal halide lamp or the like can be used as the discharge lamp 1.

The reflector 2, for example, is mounted integrally with the discharge lamp 1 and is normally formed in elliptical shape. In addition, the reflector 2 condenses the light emitted from the discharge lamp 1 and focuses the light thus condensed on the color wheel 3.

The color wheel 3 is rotated at a high speed by the motor 8 rotatably mounted to the color wheel 3, so that the color of the light made incident to the DMD element 5 is changed from R to B through G in order. Thus, the image in accordance with the color corresponding to the illumination light emitted on the optical path is displayed on the DMD element 5, thereby making it possible to represent the image having the color concerned. In general, the color wheel 3 adopts a six-segment system in which segments of R, G, B, and R, G, B are disposed in order at intervals of 60° on the same circumference.

The DMD element 5 is formed in one sheet of panel by, for example, spreading about 800,000 fine mirror elements all over a semiconductor element having a size of 17 mm×13 mm. These fine mirror elements are mounted to one or more hinges disposed in a post so as to be each movable within the range of about ±10°. That is to say, in the DMD element 5, one fine mirror element corresponds to one pixel. The DMD element 5 operates so that when one fine mirror element of the DMD element 5, for example, is inclined at an angle of +10°, the light emitted from the discharge lamp 1 is reflected by the one fine mirror element of the DMD element 5 to be made incident to the projection lens 6, while one fine mirror element of the DMD element 5, for example, is inclined at the angle of −10°, no reflected light is made incident to the projection lens 6.

The control portion 9 includes a CPU, a ROM, a RAM, an image memory and the like. Also, the control portion 9 includes a configuration and software for rotating the color wheel 3, and controlling the driving of the corresponding ones of the fine mirror elements of the DMD elements 5 at individual timings at which the color filters of the color wheel 3 are successively interposed on the optical path in accordance with the image data stored in the image memory or taken therein from the outside.

[Operation of Image Displaying Apparatus]

Next, an operation of the image displaying apparatus 100 shown in FIG. 1 will now be described. When the control portion 9 and the power source unit 10 for a discharge lamp operate to rotate the motor 8 and to turn ON the discharge lamp 1, the light emitted from the discharge lamp 1 reaches the color wheel 3 to be separated in color into R, G and B in this order in accordance with the rotation of the color wheel 3.

The condenser lens 4 converts the color light emitted from the color wheel 3 to the optical path into the parallel light which is in turn radiated to the DMD element 5. In the DMD element 5, the corresponding ones of the fine mirror elements reflect the R, G or B light made incident thereto under the control by the control portion 9. At this time, the operation for inclining all the fine mirror elements of the DMD element 5 is digitally controlled in correspondence to an image signal, thereby displaying an image on the projection surface of the screen 7 in an enlarged form. The color light reflected by the DMD element 5 reaches the projection lens 6, and is then projected on the projection surface of the screen 7 by the projection lens 6.

Although the R, G and B images are successively projected on the projection surface of the screen 7 by the projection lens 6, they are switched over to one another at a high frequency. Hence, a viewer who enjoys the image on the screen 7 perceives the image as one in which R, G and B are mixed with one another. As a result, the color image can be obtained.

[Structure of Power Source Unit for Discharge Lamp]

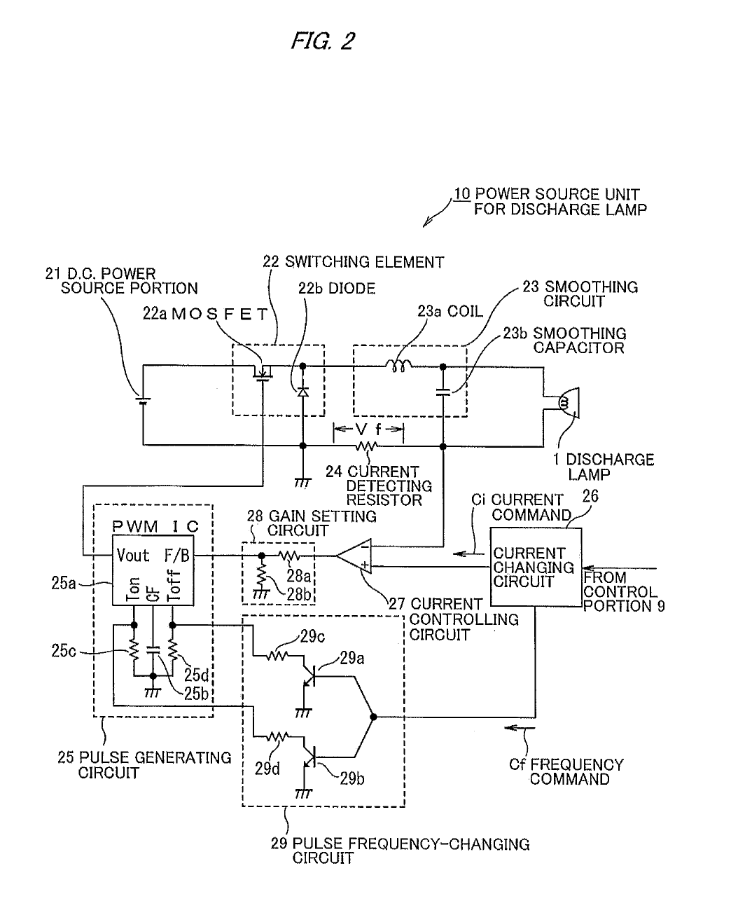

FIG. 2 shows a detailed circuit structure of the power source unit 10 for a discharge lamp. The power source unit 10 for a discharge lamp includes a D.C. power source portion 21, a switching element 22 connected to the D.C. power source portion 21, a smoothing circuit 23 for smoothing an output current from the switching element 22, a current detecting resistor 24 connected between a negative polarity terminal of the D.C. power source portion 21 and a low potential side of the discharge lamp 1, a pulse generating circuit 25 for controlling the switching element 22 in accordance with a pulse width modulation (PWM) system, a current changing circuit 26 for outputting a current command Cᵢ in accordance with which a value of a lamp current to be caused to flow through the discharge lamp 1 is determined, and a frequency command C_{f} in accordance with which a pulse frequency of a lamp current to be caused to flow through the discharge lamp 1 is determined, a current controlling circuit 27 for outputting a deviation value between the current command Cᵢ and a detected voltage V_{f} developed across the current detecting resistor 24, a gain setting circuit 28 for setting an output voltage from the current controlling circuit 27 at a predetermined level, and outputting the resulting voltage to the pulse generating circuit 25, and a pulse frequency-changing circuit 29 for changing an oscillation frequency of the pulse generating circuit 25 to another one in accordance with the frequency command C_{f}.

Here, in FIG. 2, a feedback control system is constituted by the switching element 22, the smoothing circuit 23, the discharge lamp 1, the current detecting resistor 24, the current controlling circuit 27, the gain setting circuit 28, the pulse generating circuit 25, and the switching element 22.

The D.C. power source portion 21, for example, is constituted by a full-wave voltage doubler-rectifying circuit for generating a D.C. voltage of about 250 to about 370 V from a commercial power source of an A.C. 100 V.

The switching element 22 includes an N-channel metal oxide semiconductor (MOS) field effect transistor (FET) 22a for switching, and a diode 22b through which an electrical energy accumulated in the smoothing circuit 23 in an OFF phase of the N-channel MOSFET 22a is caused to pass.

The smoothing circuit 23 includes a coil 23a connected between the switching element 22 and the discharge lamp 1, and a smoothing capacitor 23b connected in parallel with the discharge lamp 1.

The pulse generating circuit 25 includes a PWMIC 25a, a capacitor 25b connected to an oscillation capacitance terminal CF of the PWMIC 25a, and resistors 25c and 25d connected to an oscillation resistance terminals Tₒₙ and T_{off}, respectively. The selection of the values of the capacitor 25b, and the resistors 25c and 25d determines an oscillation frequency of a triangular oscillation waveform of the pulse. More specifically, an inclination of an up-grade of the triangular oscillation waveform of the pulse depends on the product of a capacitance value of the capacitor 25b and a resistance value of the resistor 25c, while an inclination of a down-grade of the triangular oscillation waveform thereof depends on the product of the capacitance value of the capacitor 25b and a resistance value of the resistor 25d.

The current controlling circuit 27 includes an operational amplifier which receives as its inputs the detected voltage V_{f} developed across the current detecting resistor 24, and the current command Cᵢ. While being omitted in illustration, a power source circuit for supplying a suitable voltage to the IC and the individual circuits is specially prepared for.

The gain setting circuit 28 is connected in series between an output terminal of the current controlling circuit 27 and the earth, and includes resistors 28a and 28b for resistance-dividing an output voltage from the current controlling circuit 27, and outputting the resulting voltage to a feedback terminal F/B of the PWMIC 25a.

The pulse frequency-changing circuit 29 includes transistors 29a and 29b. Here, the frequency command Q is inputted to each of bases of the bipolar transistors 29a and 29b, and both emitters of the bipolar transistors 29a and 29b are grounded. A collector of the bipolar transistor 29a is connected to the oscillation resistance terminal T_{off} through the resistor 29c, and a collector of the bipolar transistor 29b is connected to the oscillation resistance terminal Tₒₙ through the resistor 29d.

[Operation of Power Source Unit for Discharge Lamp]

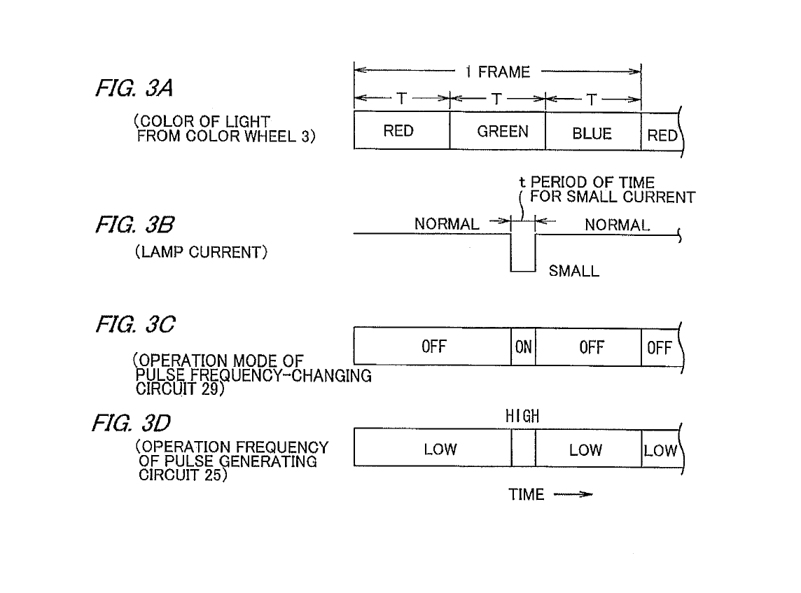

Next, an operation of the power source unit 10 for a discharge lamp shown in FIG. 2 will now be described. FIGS. 3A to 3D are respectively timing charts showing operations of the respective portions of the power source unit for a discharge lamp shown in FIG. 2. In these timing charts of FIGS. 3A to 3D, FIG. 3A shows the lights which are successively transmitted through the color wheel 3 to have the three primary colors, respectively, FIG. 3B shows a timing at which a small lamp current is caused to flow through the discharge lamp only for a period of time for a small lamp current, FIG. 3C shows an operation mode of the pulse frequency-changing circuit, and FIG. 3D shows a state of an operation frequency of the pulse generating circuit. Here, three periods, T, of time for which the lights are transmitted through the color wheel 3 to have the three primary colors R, G and B, respectively, correspond to one frame of a color image.

The D.C. voltage outputted from the D.C. power source portion 21 is applied to the switching element 22. The switching element 22 is PWM-controlled in accordance with the control by the pulse generating circuit 25 which operates at a predetermined frequency (for example, 70 kHz) and with a set value of the current, so that a current having a rectangular waveform is supplied to the smoothing circuit 23 to be smoothed thereby. Also, the current smoothed by the smoothing circuit 23 is caused to flow through the discharge lamp 1 to turn ON the discharge lamp 1.

A voltage drop (detected voltage V_{f}) is developed across the current detecting resistor 24 by causing the smoothed current to flow through the discharge lamp 1, and the detected voltage V_{f} is then inputted to an inverted input terminal of the current controlling circuit 27. The current controlling circuit 27 generates such an output voltage that a voltage to be inputted to the feedback terminal F/B of the pulse generating circuit 25 gets a constant value in accordance with a difference between the detected voltage V_{f} and the value of the current command Cᵢ inputted from the current changing circuit 26 to a non-inverted input terminal of the current controlling circuit 27.

On the other hand, the pulse frequency-changing circuit 29 holds each of the bipolar transistors 29a and 29b in an ON state as shown in FIG. 3C only for a partial period, t, of time (a period of time for a small lamp current) of the period, T, of time for display of green shown in FIG. 3A in accordance with the frequency command C_{f} issued from the current changing circuit 26. Thus, the resistance values of the resistors 25c and 25d connected in series between the oscillation resistance terminals T_{off} and Tₒₙ of the pulse generating circuit 25 and the earth are changed only for the period, t, of time. As a result, as shown in FIG. 3D, the oscillation frequency (operation frequency) of the pulse generating circuit 25 is held high only for the period, t, of time for a small lamp current. For example, the oscillation frequency of the pulse generating circuit 25 is doubled, that is, changed from 70 kHz to 140 kHz. The period, t, of time, for example, is set in the range of 1/400 to ¼ of the period, T, of time for display of green. The lamp current which is caused to flow through the discharge lamp 1 is reduced only for the period, t, of time in accordance with this control, thereby reducing an emission output, of the discharge lamp 1, for display of green.

According to the embodiment of the invention, the following effects are offered.

(1) Since the switching frequency of the switching element 22 is held high only for the partial period, t, of time within the period, T, of time, for display of a specific color, for which the emission output of the discharge lamp 1 is held high, the circuit structure of the power source unit 10 for a discharge lamp can be simplified.

(2) The adoption of the constitution stated in (1) makes it unnecessary to take measures to cope with the reduction in switching efficiency and the heat in the switching operation because the switching loss for the period, T, of time is prevented from increasing. Consequently, it is possible to prevent the cost from increasing.

Note that, in the above-mentioned embodiment, the oscillation frequency of the pulse generating circuit 25 for the period, t, of time for a small lamp current is made twice as high as that of the pulse generating circuit 25 for the period, T, of time. However, even when the oscillation frequency of the pulse generating circuit 25 for the period, t, of time for a small lamp current, for example, is made 1.5 to 2.5 times as high as that of the pulse generating circuit 25 for the period, T, of time, the same effect as that in the above-mentioned embodiment can be obtained.

Next, an example of the invention will now be described.

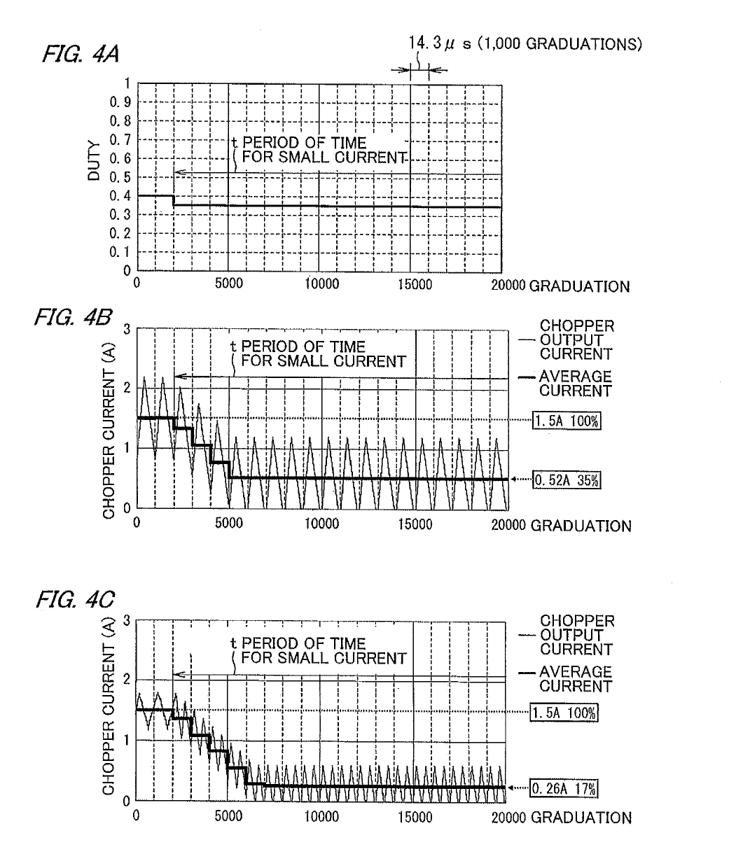

FIGS. 4A to 4C show respectively characteristics when a duty for an ON period of time of the switching element is changed in order to reduce a quantity of light emitted from the discharge lamp. That is to say, FIG. 4A is a waveform chart showing a change in duty of the switching element, FIG. 4B is a characteristic diagram showing a triangular waveform of the lamp current caused to flow through the discharge lamp and an average value of the triangular waveform of the lamp current when no oscillation frequency of the pulse generating circuit is changed, and FIG. 4C is a characteristic diagram showing a triangular waveform of the lamp current caused to flow through the discharge lamp and an average value of the triangular waveform of the lamp current in the example of the invention. Here, an axis of abscissa in each of FIGS. 4A to 4C represents one period of 70 kHz, that is, 14.3 μsec. as 1,000 graduations. In addition, an inductance of the coil 23a is set as 700 μH.

In the characteristics shown in FIG. 4A, the duty of the switching element 22 in which an ON state and an OFF state alternate with a period of 70 kHz is changed from 0.4 to 0.35.

FIG. 4B shows the triangular waveform of the lamp current caused to flow through the discharge lamp and the average value of the triangular waveform of the lamp current. An observation for a situation of a reduction in lamp current in FIG. 4B shows that the reduction in lamp current is stopped whenever a part of the triangular waveform of the current reaches 0 A, that is, the current caused to flow through the coil 23a reaches a state called a discontinuous mode. The average current at this time is 0.52 A, and corresponds to an amount of current of about 35% (={(0.52/1.5)×100} when an initial current (1.5 A) is regarded as 100%. This means that although the lamp current occupying 50% of the lamp current in the initial operation can be caused to flow through the discharge lamp 1 for the period, t, of time for a small lamp current shown in FIG. 3, the lamp current occupying 25% of the lamp current in the normal operation cannot be caused to flow through the discharge lamp 1.

In order to avoid the nonconformity described above, the discontinuous mode must be inhibited from being generated when the lamp current is reduced for the period, t, of time for a small lamp current. In order to attain this, it is necessary to reduce an amplitude of the triangular waveform of the current, that is, an amount of current generally called a current ripple. As one of methods of reducing the amount of current ripple, there is a method of increasing the pulse frequency of the switching element 22.

For example, when the pulse frequency of the switching element 22 is increased from 70 kHz to 140 kHz, an average current becomes 0.26 A. This average current corresponds to 17% of the initial current of 15 A (100%), which results in that the lamp current caused to flow through the discharge lamp 1 for the period, t, of time for a small lamp current can be set as 25%.

However, with regard to the inconvenience in the method described above, there is caused such a problem that the reduction in switching efficiency is caused or measures to cope with the heat must be taken since the switching loss of the switching element 22 increases in proportion to an increase in switching frequency.

Then, when the switching element 22 was driven under a condition that in FIGS. 3A to 3D, the switching frequency for the period, T, of time was set to 70 kHz, and the switching frequency for the period, t, of time for a small lamp current was set to 140 kHz, the results shown in FIG. 4C were obtained. As a result, as shown in FIG. 4C, an average current for the period, t, of time for a small lamp current became 0.26 A. This average current corresponded to 17% of the initial current of 1.5 A (100%), which resulted in that the lamp current caused to flow through the discharge lamp 1 for the period, t, of time for a small lamp current could be set as 25%. Consequently, it is possible to perform the reduction in lamp current required for the period of time for display of the green image.

It should be noted that the invention is not intended to be limited to the above-mentioned embodiment, and the various kinds of changes can be made by those skilled in the art without changing the gist of the invention.

For example, although the above-mentioned embodiment adopts the D.C. driving system in which the discharge lamp 1 is driven by the D.C. current obtained through the switching operation of the switching element 22, the discharge lamp 1 may also be driven in accordance with an A.C. driving system. In this case, a discharge lamp corresponding to the A.C. driving system is used as the discharge lamp 1.

In the above-mentioned embodiment, the lamp current caused to flow through the discharge lamp 1 is controlled for G of the three primary colors R, G and B. However, the invention is not limited to the control for G, and thus can be applied to a discharge lamp having such characteristics that a specific light is not balanced with other lights having respective wavelength bands.

In addition, the circuit structures of the pulse generating circuit 25 and the pulse frequency-changing circuit 29 shown in FIG. 2 are merely one example, and thus any suitable circuit structures may be adopted for the pulse generating circuit 25 and the pulse frequency-changing circuit 29 as long as they exhibit the same functions as those shown in FIG. 2.

What is claimed is:

1. A power source unit for a discharge lamp, wherein a lamp current caused to flow through the discharge lamp which is driven by a switching element by using a D.C. power source as a power source has a period of time for a large lamp current and a period of time for a small lamp current, the discharge lamp is driven for the period of time for a large lamp current by a high-frequency pulse having a first frequency, and the discharge lamp is driven for the period of time for a small lamp current by a high-frequency pulse having a second frequency higher than the first frequency.

2. A power source unit for a discharge lamp according to claim 1, wherein the period of time for a large lamp current of the lamp current is longer than the period of time for a small lamp current.

3. A power source unit for a discharge lamp according to claim 1, wherein the period of time for a small lamp current of the lamp current is in a range of 1/400 to ⅓ of the period of time for a large lamp current during a period of time for display of a certain display color.

4. A power source unit for a discharge lamp according to claim 1, wherein the second frequency is 1.5 to 2.5 times as high as the first frequency.

5. A power source unit for a discharge lamp according to claim 1, wherein the period of time for a small lamp current of the lamp current is in a period of time for display of a green display color.

6. A power source unit for a discharge lamp according to claim 1, wherein the discharge lamp is a light source used for a projection type image displaying apparatus.

7. A power source unit for a discharge lamp, comprising:
a switching element for driving the discharge lamp by using a D.C. power source as a power source;
a pulse generating circuit for switching the switching element by a high-frequency pulse; and
a pulse frequency-changing circuit for controlling the pulse generating circuit so that the pulse generating circuit generates the high-frequency pulse with a first frequency for a first period of time within a predetermined period of time which is periodically repeated, and generates the high-frequency pulse with a second frequency higher than the first frequency within the predetermined period of time.

8. A power source unit for a discharge lamp according to claim 7, wherein the second period of time is in a range of 1/400 to ¼ of the predetermined period of time.

9. A power source unit for a discharge lamp according to claim 7, wherein the second frequency is 1.5 to 2.5 times as high as the first frequency.

10. A power source unit for a discharge lamp according to claim 7, wherein the first period of time is in the predetermined period of time, but except for the second period of time.

11. A power source unit for a discharge lamp according to claim 7, wherein the predetermined period of time is a period of time for display of a green display color.

12. A power source unit for a discharge lamp according to claim 7, wherein the discharge lamp is a light source used for a projection type image displaying apparatus.

13. A method of controlling a power source unit for a discharge lamp, comprising the steps of:
driving the discharge lamp for a period of time for a large lamp current of the period of time for a large lamp current and a period of time for a small lamp current by a high-frequency pulse having a first frequency, a lamp current caused to flow through the discharge lamp driven by a switching element by using a D.C. power source as a power source having the period of time for a large lamp current and the period of time for a small lamp current; and
driving the discharge lamp for the period of time for a small lamp current by using a high-frequency pulse having a second frequency higher than the first frequency.

14. A method of controlling a power source unit for a discharge lamp according to claim 13, wherein the period of time for a large lamp current of the lamp current is longer than the period of time for a small lamp current.

15. A method of controlling a power source unit for a discharge lamp according to claim 13, wherein the period of time for a small lamp current of the lamp current is in a range of 1/400 to ⅓ of the period of time for a large lamp current during a period of time for display of a certain display color.

16. A method of controlling a power source unit for a discharge lamp according to claim 13, wherein the second frequency is 1.5 to 2.5 times as high as the first frequency.

17. A method of controlling a power source unit for a discharge lamp according to claim 13, wherein the period of time for a small lamp current of the lamp current is in a period of time for display of a green display color.

18. A method of controlling a power source unit for a discharge lamp according to claim 13, wherein the discharge lamp is a light source used for a projection type image displaying apparatus.
